(19) United States
(12) Patent Application Publication
(10) Pub. No.: US 2024/0135227 A1
(43) Pub. Date: Apr. 25, 2024

(54) GENERATING IN-DISTRIBUTION SAMPLES OF TIME-SERIES OR IMAGE DATA FOR THE NEIGHBORHOOD DISTRIBUTION

(71) Applicant: International Business Machines Corporation, Armonk, NY (US)

(72) Inventors: Natalia Martinez Gil, Durham, NC (US); Kanthi Sarpatwar, Elmsford, NY (US); Roman Vaculin, Larchmont, NY (US)

(21) Appl. No.: 17/961,277

(22) Filed: Oct. 6, 2022

(51) Int. Cl. G06N 20/00

(52) U.S. Cl. CPC G06N 20/00

(57) ABSTRACT

A computer-implemented method, system and computer program product for generating in-distribution samples of data for a neighborhood distribution to be used by post-hoc local explanation methods. An autoencoder is trained to generate in-distribution samples of input data for the neighborhood distribution to be used by a post-hoc local explanation method. Such training includes mapping the input data (e.g., time series data) into a latent dimension (or latent space) forming a first and a second latent code. A mixed code is then obtained by convexly combining the first and second latent codes with a random coefficient. The mixed code is then decoded with the input data masked with interpretable features to obtain conditional mixed reconstructions. Adversarial training is then performed against a discriminator in order to promote in-distribution samples by computing the reconstruction losses of the conditional mixed reconstructions as well as the discriminator losses and then minimizing such losses.

### TECHNICAL FIELD

The present disclosure relates generally to artificial intelligence methods, and more particularly to generating in-distribution samples of time-series or image data for the neighborhood distribution to be used by post-hoc local explanation methods.

### BACKGROUND

Blackbox artificial intelligence (AI) methods (e.g., deep neural networks) have been widely utilized to build predictive models that can extract complex relationships in a dataset and make predictions for new unseen data records. However, it is difficult to trust decisions made by such methods since their inner working and decision logic is hidden from the user. Post-hoc local explanation methods approximate the behavior of a black-box by extracting the relationships between feature values and the predictions.

### SUMMARY

In one embodiment of the present disclosure, a computer-implemented method for generating in-distribution samples of data for a neighborhood distribution to be used by post-hoc local explanation methods comprises training an autoencoder to generate in-distribution samples of input data for the neighborhood distribution to be used by a post-hoc local explanation method. The training comprises mapping the input data into a latent dimension forming a first latent code and a second latent code by an encoder. The training further comprises obtaining a mixed code by convexly combining the first and second latent codes with a random coefficient by a mixing block. The training additionally comprises decoding the mixed code along with the input data masked with interpretable features to obtain conditional mixed reconstructions by a decoder. Furthermore, the training comprises performing adversarial training against a discriminator by computing reconstruction losses of the conditional mixed reconstructions and computing discriminator losses and minimizing the reconstruction losses and the discriminator losses.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the in-distribution sample generator used to generate in-distribution samples of data for a neighborhood distribution to be used by post-hoc local explanation methods in accordance with an embodiment of the present disclosure;

FIG. 3 illustrates the architecture of the autoencoder in accordance with an embodiment of the present disclosure;

FIG. 4 illustrates the mixed reconstruction losses in accordance with an embodiment of the present disclosure;

FIG. 5 illustrates an embodiment of the present disclosure of the hardware configuration of the in-distribution sample generator which is representative of a hardware environment for practicing the present disclosure;

FIG. 6 is a flowchart of a method for training an autoencoder to generate in-distribution samples of input data for the neighborhood distribution to be used by a post-hoc local explanation method in accordance with an embodiment of the present disclosure; and

FIG. 7 is a flowchart of a method for performing neighborhood sampling for a given instance in accordance with an embodiment of the present disclosure.

### DETAILED DESCRIPTION

As stated in the Background section, blackbox artificial intelligence (AI) methods (e.g., deep neural networks) have been widely utilized to build predictive models that can extract complex relationships in a dataset and make predictions for new unseen data records. However, it is difficult to trust decisions made by such methods since their inner working and decision logic is hidden from the user. Post-hoc local explanation methods approximate the behavior of a black-box by extracting the relationships between feature values and the predictions.

An example of a post-hoc local explanation method is the local interpretable model-agnostic explanation (LIME) method. LIME is a method that fits a surrogate glassbox model around the decision space of any blackbox model's prediction. LIME explicitly tries to model the local neighborhood (feasible solution space used to find the optimum or near optimum solution for the problem) of any prediction—by focusing on a narrow enough decision surface. Users can then inspect the glassbox model to understand how the blackbox model behaves in that region.

LIME works by perturbing any individual datapoint (perturbations correspond to small changes in the system, such as small changes in the gradients, weights, inputs, etc.) and generating synthetic data which gets evaluated by the blackbox system, and ultimately used as a training set for the glassbox model. LIME's advantages are that you can interpret an explanation the same way you reason about a lineal model, and that it can be used on almost any model.

Unfortunately, post-hoc local explanation methods, such as LIME, rely on neighborhood distributions to generate evaluation points. For particular inputs, such as time-series or image data, standard neighborhood generation methods may produce out of distribution examples or a limited type of perturbation. Such out of distribution examples or limited types of perturbations have a negative impact on the learned explanations, such as by omitting the relevant features that affect the decision of the post-hoc local explanation method. That is, such out of distribution examples or limited types of perturbations may result in misleading or non-local explanations thereby affecting the decision of the post-hoc local explanation method.

Unfortunately, there is not currently a means for generating in-distribution samples of time-series or image data for the neighborhood distribution to be used by post-hoc local explanation methods thereby improving the accuracy of the decision making ability of the post-hoc local explanation method.

The embodiments of the present disclosure provide a means for generating in-distribution samples of time-series or image data for the neighborhood distribution to be used by post-hoc local explanation methods utilizing ideas from adversarial mix-up resynthesis as discussed further below.

In some embodiments of the present disclosure, the present disclosure comprises a computer-implemented method, system and computer program product for generating in-distribution samples of data for a neighborhood distribution to be used by post-hoc local explanation methods. In one embodiment of the present disclosure, an autoencoder is trained to generate in-distribution samples of input data for the neighborhood distribution to be used by a post-hoc local explanation method. An “autoencoder,” as used herein, is an unsupervised artificial neural network that learns how to efficiently compress and encode data and then learns how to reconstruct the data from the reduced encoded representation to a representation that is as close to the original input as possible. In one embodiment, an autoencoder is trained to reconstruct its inputs after being processed by two neural networks: an encoder which encodes the input to a high-level representation and a decoder which performs the reconstruction using that representation as input. Such training includes mapping the input data, such as time series or image data, into a latent dimension (or latent space) forming a first latent code and a second latent code. “Latent space,” as used herein, refers to a representation of compressed data in which similar data points are closer together in space. That is, latent space refers to an abstract multi-dimensional space containing feature values that cannot be interpreted directly, but which encodes a meaningful internal representation of externally observed events. Such feature values are referred to as “latent codes.” A mixed code is then obtained by convexly combining the first and second latent codes with a random coefficient. The mixed code is then decoded with the input data masked with interpretable features (features having a semantic content) to obtain conditional mixed reconstructions. The input data masked with interpretable features indicates which portions of the input data contain interpretable features. Adversarial training is then performed against a discriminator in order to promote in-distribution samples by computing the reconstruction losses of the conditional mixed reconstructions as well as the discriminator losses and then minimizing such losses. Upon training the autoencoder to generate in-distribution samples of input data for the neighborhood distribution to be used by a post-hoc local explanation method, a sampling procedure may be utilized to generate neighborhood samples for a given input using the trained autoencoder while controlling the maximum distortion level. In this manner, the principles of the present disclosure generate in-distribution samples of time-series or image data for the neighborhood distribution that are used by post-hoc local explanation methods thereby improving the decision making ability of the post-hoc local explanation method.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill the relevant art.

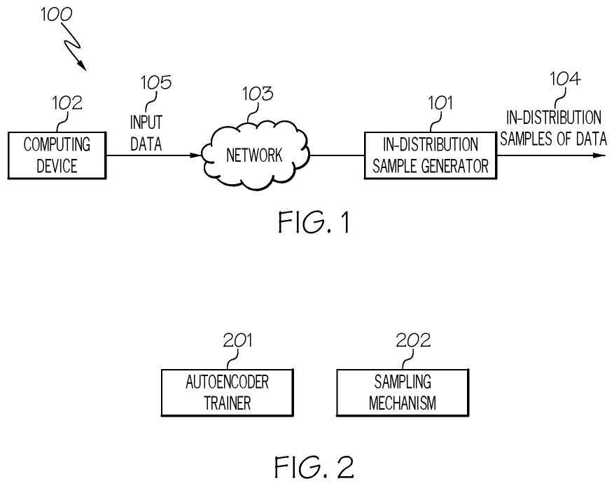

Referring now to the Figures in detail, FIG. 1 illustrates an embodiment of the present disclosure of a communication system 100 for practicing the principles of the present disclosure. Communication system 100 includes an in-distribution sample generator 101 connected to a computing device 102 via a network 103. In one embodiment, in-distribution sample generator 101 is configured to generate in-distribution samples of data 104 for a neighborhood distribution to be used by post-hoc local explanation methods using input data 105 (e.g., time series or image data) provided by a user of computing device 102 as discussed in further detail below.

Computing device 102 may be any type of computing device (e.g., portable computing unit, Personal Digital Assistant (PDA), laptop computer, mobile device, tablet personal computer, smartphone, mobile phone, navigation device, gaming unit, desktop computer system, workstation, Internet appliance and the like) configured with the capability of connecting to network 103 and consequently communicating with other computing devices 102 and in-distribution sample generator 101. It is noted that both computing device 102 and the user of computing device 102 may be identified with element number 102.

Network 103 may be, for example, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

As discussed above, in-distribution sample generator 101 is configured to generate in-distribution samples of data 104 for a neighborhood distribution to be used by post-hoc local explanation methods using input data 105 (e.g., time series or image data) provided by a user of computing device 102. In one embodiment, such in-distribution samples of data 104 for a neighborhood distribution to be used by post-hoc local explanation methods (e.g., local interpretable model-agnostic explanation method) are generated using the ideas from adversarial mix-up resynthesis. In post-hoc local explanation methods, masked areas (portions of data that are sampled according to a distribution) may be effectively zeroed out thereby resulting in out of distribution samples. Using the principles of the present disclosure, such masked areas are replaced using segments drawn from a distribution learned on training data. Such segments (Z-localized perturbations corresponding to portions of an instance of the input data to be perturbed) are obtained using the ideas from adversarial mix-up resynthesis. A more detailed description of these and other features is provided below.

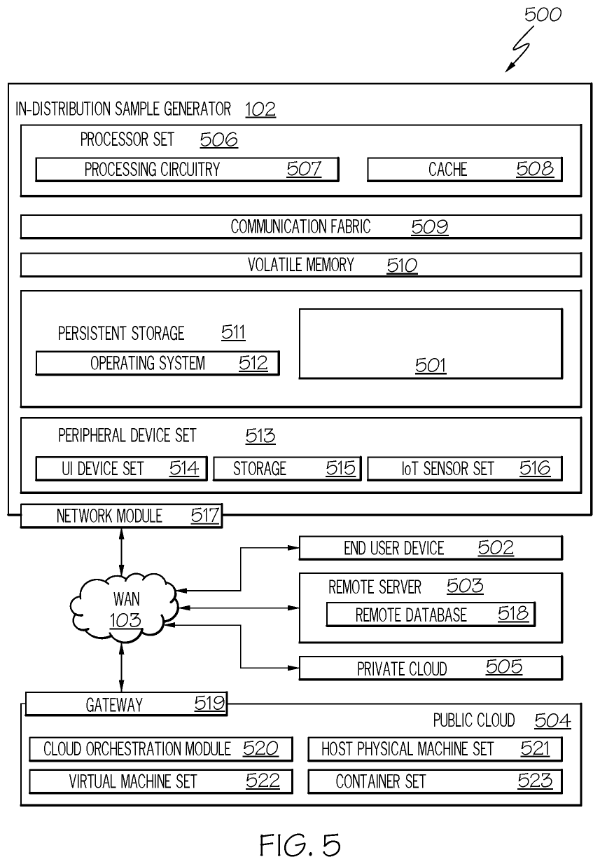

Furthermore, a description of the software components of in-distribution sample generator 101 is provided below in connection with FIG. 2 and a description of the hardware configuration of in-distribution sample generator 101 is provided further below in connection with FIG. 5.

System 100 is not to be limited in scope to any one particular network architecture. System 100 may include any number of in-distribution sample generators 101, computing devices 102 and networks 103.

A discussion regarding the software components used by in-distribution sample generator 101 to generate in-distribution samples of data 104 for a neighborhood distribution to be used by post-hoc local explanation methods is provided below in connection with FIG. 2.

FIG. 2 is a diagram of the software components of in-distribution sample generator 101 used to generate in-distribution samples of data 104 for a neighborhood distribution to be used by post-hoc local explanation methods in accordance with an embodiment of the present disclosure.

Referring to FIG. 2, in conjunction with FIG. 1, in-distribution sample generator 101 includes an autoencoder trainer 201 configured to train an autoencoder to generate in-distribution samples of input data for the neighborhood distribution to be used by a post-hoc local explanation method. An “autoencoder,” as used herein, is an unsupervised artificial neural network that learns how to efficiently compress and encode data and then learns how to reconstruct the data from the reduced encoded representation to a representation that is as close to the original input as possible.

In adversarial mix-up resynthesis, an autoencoder is trained to decode mixes of latent codes as realistic images. In one embodiment, autoencoder trainer 201 applies ideas from adversarial mix-up resynthesis to generate Z-localized perturbations corresponding to portions of an instance of the input data to be perturbed as discussed further below.

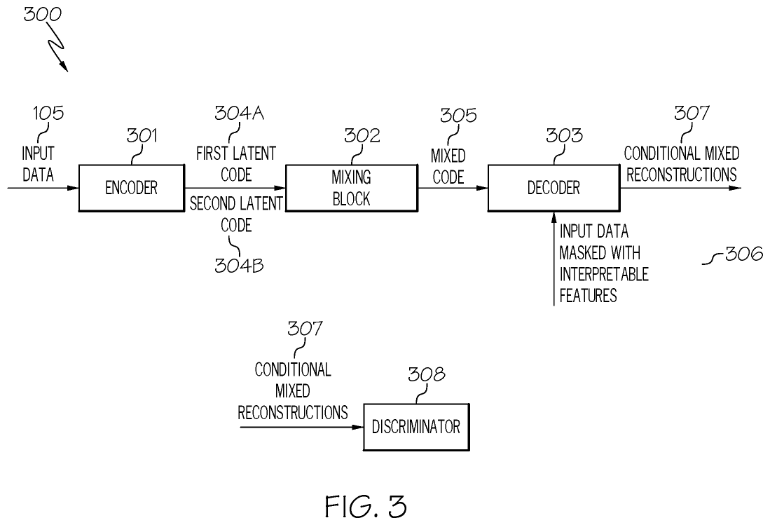

In one embodiment, an autoencoder is trained by autoencoder trainer 201 to reconstruct its inputs after being processed by two neural networks: an encoder which encodes the input to a high-level representation and a decoder which performs the reconstruction using that representation as input. One goal of the autoencoder is to learn representations of the input data which are useful, which may help in downstream tasks, such as classification or reinforcement learning. That is, the autoencoder allows one to reduce dimensionality and focus on areas of importance. In one embodiment, the autoencoder is a convolution autoencoder, a sparse autoencoder, a deep autoencoder or a contractive autoencoder. An illustration of an exemplary architecture of an autoencoder is shown in FIG. 3.

Referring to FIG. 3, FIG. 3 illustrates the architecture of autoencoder 300 in accordance with an embodiment of the present disclosure. In one embodiment, autoencoder 300 includes an encoder 301, a mixing block 302 and a decoder 303. An explanation of the functionality of such components is provided below in connection with autoencoder trainer 201.

Referring to FIG. 2, in conjunction with FIGS. 1 and 3, autoencoder trainer 201 receives an interpretable feature map, where the interpretable feature map captures features in the space of input data 105, such as time series or image data. In one embodiment, such a feature map captures the features (e.g., points, lines, edges, objects, areas) in the space of input patterns. Features are deemed to be interpretable if the features have a semantic content as opposed to uninterpretable features, which are features that are devoid of semantic content.

In one embodiment, the interpretable feature map is generated by applying filters or feature detectors to input data 105 or the feature map output of the prior layers of a convolutional neural network. For example, in one embodiment, the interpretable feature map is the output of one filter applied to a previous layer. A given filter is drawn across the entire previous layer, moved one pixel at a time. Each position results in an activation of the neuron and the output is collected in the feature map.

In one embodiment, such an interpretable feature map is generated via the use of labels, where the map includes the labeled features. In one embodiment, a label size is used to reduce the number of small features that are being labeled. For example, for those features that are insignificant that do not require a label, a minimum feature size can be specified whereby features that are smaller than such a minimum feature size will not be labeled. In one embodiment, such a minimum feature size is determined by an expert. In one embodiment, various software tools may be utilized by autoencoder trainer 201 to label features to be used to generate an interpretable feature map, including, but not limited to, doccano, Label studio, Universal data tool, awesome data labelling, labelbox®, V7, ImgLab, supervisely, SuperAnnotate, Dataloop®, VoTT, etc.

In one embodiment, encoder 301 of autoencoder 300 maps input data 105 (e.g., time series or image data) into a latent dimension or latent space forming a first latent code 304A and a second latent code 304B. In one embodiment, such input data 105 involves pairs of samples which are mapped into a latent dimension using encoder 301 forming first latent code 304A and a second latent code 304B. Latent codes 304A-304B may collectively or individually be referred to as latent codes 304 or latent code 304, respectively.

A “latent space,” as used herein, refers to a representation of compressed data in which similar data points are closer together in space. Latent space is useful for learning data features and for finding simpler representations of data for analysis. That is, latent space refers to an abstract multi-dimensional space containing feature values that cannot be interpreted directly, but which encodes a meaningful internal representation of externally observed events. Such feature values are referred to as “latent codes.”

Examples of the latent space include, but not limited to, image feature space, a variational autoencoder, a generative adversarial network, etc.

For example, encoder 301 may receive inputs χ and χ₁ which produce e_{χ} and e_{χ}_{₁}, representing the first and second latent codes 304A, 304B.

In one embodiment, mixed code 305 is obtained by convexly combining the first and second latent codes 304A, 304B with a random coefficient by mixing block 302 of autoencoder 300. For example, mixing block 302 may convexly combine latent codes 304A, 304B with the random coefficient, αe_{χ}+·(1−α)e_{χ}_{₁}, to produce the convex combination e_{(χ,χ}_{₁}₎^{mix}. Such a convex combination may be represented as follows:

e_{(X,X}_{₁}₎^{mix}=αe_{X}+(1−α)e_{X}_{₁}, α˜U[0,1]

Decoder 303 may then decode mixed code 305 with input data masked with the interpretable features (see element 306) obtained from the interpretable feature map to obtain conditional mixed reconstructions 307. The input data masked with interpretable features indicates which portions of the input data contain interpretable features. For example, input data masked with interpretable features may be represented as X∘Z, where Z represents the mask of interpretable features and X represents the input data. The output of decoder 303 corresponds to the conditional mixed reconstructions 307, represented by \hat{χ}, which corresponds to the neighborhood samples. The conditional mixed reconstruction 307 may be represented as follows:

X=d_{⊥}(e_{(X,X}_{₁}₎^{mix}, X∘Z)

In one embodiment, in order to promote Z-localized perturbations (perturbations correspond to small changes in the system, such as small changes in the gradients, weights, inputs, etc.), decoder 303 is conditioned on mask Z and includes a reconstruction loss. “Z-localized perturbations,” as used herein, refer to portions of an instance of input data 105 to be perturbed.

In one embodiment, autoencoder trainer 201 utilizations various software tools for building autoencoder 300, including the components of autoencoder 300 discussed above, including, but not limited to, Keras, DeepPy, neon, etc.

In one embodiment, autoencoder trainer 201 runs a discriminator 308 against the output of autoencoder 300 (e.g., conditional mixed reconstructions 307). In one embodiment, the result is used to influence the cost function used to update the autoencoder's weights.

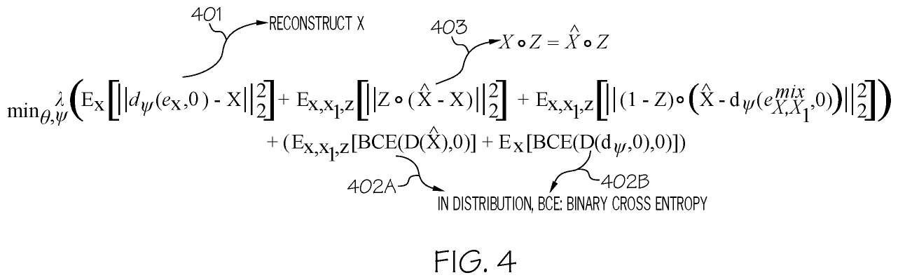

In one embodiment, in order to promote in-distribution samples, autoencoder trainer 301 performs adversarial training (augments training data with adversarial examples in each training loop) against discriminator 308 by computing reconstruction losses of conditional mixed reconstructions 307 and computing discriminator losses and minimizing such losses (the reconstruction losses and the discriminator losses). In one embodiment, the mixed reconstruction losses are evaluated on the masked dimensions. A representation of the mixed reconstruction losses is shown in FIG. 4.

Referring to FIG. 4, FIG. 4 illustrates the mixed reconstruction losses in accordance with an embodiment of the present disclosure. As shown in FIG. 4, the mixed reconstruction loss includes parameters for reconstructing X (input data 105) (see element 401) as well as utilizes binary cross entropy (BCE) for promoting in-distribution samples (see elements 402A, 402B) and includes samples corresponding to the dot product of Z and X, where X∘Z=\hat{X}∘Z (see element 403). Such a mixed reconstruction loss is minimized as discussed above.

Furthermore, as discussed above, in one embodiment, autoencoder trainer 201 computes the discriminator losses, which are minimized, as shown below:

min_{D} [symbol] _{X}[BCE(d₁₀₅ (e_{X}, 0)), 1)]+ [symbol] _{X,X}_{₁}_{,Z}[BCE(D(\hat{X}), 1)]+ [symbol] _{X}[BCE(D(X), 0)]

Furthermore, in one embodiment, parameters for autoencoder 300 and discriminator 308 are updated by autoencoder trainer 201 using gradient descent in order to minimize both the mixed reconstruction and discriminator losses. Gradient descent, as used herein, refers to a first-order iterative optimization algorithm for finding a local minimum of a differentiable function. In one embodiment, the gradient descent algorithm takes repeated steps in the opposite direction of the gradient of the function at the current point because this is the direction of the steepest descent.

In one embodiment, the steps of generating latent codes 304, mixed code 305 and conditional mixed reconstructions 307 as well as performing adversarial training against discriminator 308 are repeated until the performance of discriminator 308 is acceptable, such as determined by an expert.

Upon training autoencoder 300 to generate in-distribution samples of input data for the neighborhood distribution to be used by a post-hoc local explanation method, a sampling procedure may be utilized to generate neighborhood samples for a given input x using the trained autoencoder 300 while controlling the maximum distortion level as discussed below.

Given a dataset of independent input samples [symbol] ={χᵢ}ᵢ₌₁ⁿ˜P_{X}^{⊗n}, the local neighborhood sampling procedure of the present disclosure can, for any given input χ and binary interpretable features z˜Ber(1−p)^{⊗}^{^{M}}, generate neighborhood samples \hat{χ} that satisfy Z-localized perturbations (perturbations correspond to small changes in the system, such as small changes in the gradients, weights, inputs, etc.), in-distribution and distortion control. The Z-localized perturbations correspond to portions of an instance of the input data to be perturbed. The Z-localized perturbations may be represented as \hat{χ}o \hat{Z}=χ∘\hat{Z}, where \hat{Z}=mask (Z), which is the mask in the input dimensions (e.g., super pixels, time stamps) associated with the interpretable features. Furthermore, in one embodiment, in-distribution is represented as P(\hat{χ}∈ [symbol] )≥P(\hat{χ}∉ [symbol] ) and distortion control is represented as: ∥χ−χ∥₂²≤δ, δ˜P_{Δ}, where P_{Δ} is a distribution over positive real numbers.

A discussion regarding such a sampling procedure that satisfies such constraints is provided below.

In one embodiment, in-distribution sample generator 101 further includes a sampling mechanism 202 configured to obtain a neighborhood sample from decoder 303.

In one embodiment, sampling mechanism 202 randomly selects a mixing sample from input data 105 using various software tools including, but not limited to, IBM® SPSS®, Stata®, JMP®, EViews, RStudio®, etc. A “mixing sample,” as used herein, refers to randomly selecting different portions of input data 105 to form a single sample of data.

For example, in one embodiment, for a given instance X, a mixing sample from dataset 105 and a maximum distortion δ are obtained:

δ:X₁˜ [symbol] , δ˜P_{Δ}

In one embodiment, sampling mechanism 202 randomly selects a mixing sample from input data 105 using various software tools including, but not limited to, IBM® SPSS®, Stata®, JMP®, EViews, RStudio®, etc.

In one embodiment, sampling mechanism 202 obtains the latent codes, latent codes 304A, 304B, of an instance of the mixing sample, such as from encoder 301.

Additionally, sampling mechanism 202 obtains an empirical estimate of the Lipschitz constant (L) of decoder 303 of autoencoder 300. In one embodiment, the empirical estimate of the Lipschitz constant (L) of decoder 303 is provided by an expert. In one embodiment, the Lipschitz constant (L) of decoder 303 is estimated after training is completed.

In one embodiment, sampling mechanism 202 computes the upper bound (maximum value, α_{M}) on a mixing coefficient (coefficient of mixing block 302, such as αe_{χ}+·(1−α)e_{χ}_{₁}, using the positions in latent space represented by latent codes 304A, 304B and the Lipschitz constant (L) of decoder 303 of autoencoder 300. The formula to compute the upper bound is the following:

$${α}_{M} = min ( \sqrt{\frac{δ}{L {‖ {e}_{x} - {e}_{{x}^{′}} ‖}_{2}^{2}}} , 1 ) , α ∈ U [ 0 , {α}_{M} ]$$

In one embodiment, such an upper bound on the mixing coefficient is computed using the distance between the latent location of a pre-selected feature value, which may be pre-selected by an expert, and the latent locations of the feature values represented by latent codes 304A, 304B thereby forming a first distance (distance between the latent location of the pre-selected feature value and the latent location of the feature value represented by latent code 304A) and a second distance (distance between the latent location of the pre-selected feature value and the latent location of the feature value represented by latent code 304B). For example, the upper bound or maximum value of the mixing coefficient (e.g., αe_{χ}+·(1−α)e_{χ}_{₁}) is computed using such distances (first and second distances), represented as e_{χ} and e_{χ}_{₁}, respectively.

In one embodiment, sampling mechanism 202 samples the interpretable features of the mixing sample forming a perturbation mask (indicating which portions of the instance of the mixing sample to be perturbed) using the trained autoencoder 300 at a sampling time with a distortion level controlled by the upper bound on the mixing coefficient and the estimation of the Lipschitz constant of decoder 303. By sampling the interpretable features of the mixing sample to form a perturbation mask, such a mask indicates which input dimensions (e.g., lines, edges, objects, etc.) will be perturbed.

In one embodiment, sampling mechanism 202 uses various software tools for such sampling, including, but not limited to, IBM® SPSS®, SAS®, Minitab®, etc.

Additionally, in one embodiment, sampling mechanism 202 obtains a corresponding neighbor sample by decoding the mixed code 305 along with the original instance of input data 105 that is masked with the perturbation mask (indicating which portions of the input data to be perturbed) by the trained autoencoder 300. This is shown by the following equations:

χ=d_{Ψ}(e_{χ,χ′}^{mix}, χ∘z)

e_{χ,χ′}^{mix}=αe_{χ′}+(1−α)e_{χ}

z˜Ber(1−p)^{⊗M}

A further description of these and other functions is provided below in connection with the discussion of the method for generating in-distribution samples of data for a neighborhood distribution to be used by post-hoc local explanation methods.

Prior to the discussion of the method for generating in-distribution samples of data for a neighborhood distribution to be used by post-hoc local explanation methods, a description of the hardware configuration of in-distribution sample generator 101 (FIG. 1) is provided below in connection with FIG. 5.

Referring now to FIG. 5, in conjunction with FIG. 1, FIG. 5 illustrates an embodiment of the present disclosure of the hardware configuration of in-distribution sample generator 101 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code 501 involved in performing the inventive methods, such as generating in-distribution samples of data for a neighborhood distribution to be used by post-hoc local explanation methods. In addition to block 501, computing environment 500 includes, for example, in-distribution sample generator 101, network 103, such as a wide area network (WAN), end user device (EUD) 502, remote server 503, public cloud 504, and private cloud 505. In this embodiment, in-distribution sample generator 101 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

In-distribution sample generator 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically in-distribution sample generator 101, to keep the presentation as simple as possible. In-distribution sample generator 101 may be located in a cloud, even though it is not shown in a cloud in FIG. 5. On the other hand, in-distribution sample generator 101 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto in-distribution sample generator 101 to cause a series of operational steps to be performed by processor set 506 of in-distribution sample generator 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 508 and the other storage media discussed below. The program instructions, and associated data, are accessed by processor set 506 to control and direct performance of the inventive methods. In computing environment 500, at least some of the instructions for performing the inventive methods may be stored in block 501 in persistent storage 511.

Communication fabric 509 is the signal conduction paths that allow the various components of in-distribution sample generator 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In in-distribution sample generator 101, the volatile memory 510 is located in a single package and is internal to in-distribution sample generator 101, but, alternatively or additionally, the volatile memory may be distributed over multiple packages and/or located externally with respect to in-distribution sample generator 101.

Persistent Storage 511 is any form of non-volatile storage for computers that is now known or to be developed in the future. The non-volatility of this storage means that the stored data is maintained regardless of whether power is being supplied to in-distribution sample generator 101 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid state storage devices. Operating system 512 may take several forms, such as various known proprietary operating systems or open source Portable Operating System Interface type operating systems that employ a kernel. The code included in block 501 typically includes at least some of the computer code involved in performing the inventive methods.

Peripheral device set 513 includes the set of peripheral devices of in-distribution sample generator 101. Data communication connections between the peripheral devices and the other components of in-distribution sample generator 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where in-distribution sample generator 101 is required to have a large amount of storage (for example, where in-distribution sample generator 101 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows in-distribution sample generator 101 to communicate with other computers through WAN 103. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the inventive methods can typically be downloaded to in-distribution sample generator 101 from an external computer or external storage device through a network adapter card or network interface included in network module 517.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates in-distribution sample generator 101), and may take any of the forms discussed above in connection with in-distribution sample generator 101. EUD 502 typically receives helpful and useful data from the operations of in-distribution sample generator 101. For example, in a hypothetical case where in-distribution sample generator 101 is designed to provide a recommendation to an end user, this recommendation would typically be communicated from network module 517 of in-distribution sample generator 101 through WAN 103 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to in-distribution sample generator 101. Remote server 503 may be controlled and used by the same entity that operates in-distribution sample generator 101. Remote server 503 represents the machine(s) that collect and store helpful and useful data for use by other computers, such as in-distribution sample generator 101. For example, in a hypothetical case where in-distribution sample generator 101 is designed and programmed to provide a recommendation based on historical data, then this historical data may be provided to in-distribution sample generator 101 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIGS. 2-4 to generate in-distribution samples of data for a neighborhood distribution to be used by post-hoc local explanation methods. In one embodiment, such components may be implemented in hardware. The functions discussed above performed by such components are not generic computer functions. As a result, in-distribution sample generator 101 is a particular machine that is the result of implementing specific, non-generic computer functions.

In one embodiment, the functionality of such software components of in-distribution sample generator 101, including the functionality for generating in-distribution samples of data for a neighborhood distribution to be used by post-hoc local explanation methods may be embodied in an application specific integrated circuit.

As stated above, blackbox artificial intelligence (AI) methods (e.g., deep neural networks) have been widely utilized to build predictive models that can extract complex relationships in a dataset and make predictions for new unseen data records. However, it is difficult to trust decisions made by such methods since their inner working and decision logic is hidden from the user. Post-hoc local explanation methods approximate the behavior of a black-box by extracting the relationships between feature values and the predictions. An example of a post-hoc local explanation method is the local interpretable model-agnostic explanation (LIME) method. LIME is a method that fits a surrogate glassbox model around the decision space of any blackbox model's prediction. LIME explicitly tries to model the local neighborhood (feasible solution space used to find the optimum or near optimum solution for the problem) of any prediction—by focusing on a narrow enough decision surface. Users can then inspect the glassbox model to understand how the blackbox model behaves in that region. LIME works by perturbing any individual datapoint (perturbations correspond to small changes in the system, such as small changes in the gradients, weights, inputs, etc.) and generating synthetic data which gets evaluated by the blackbox system, and ultimately used as a training set for the glassbox model. LIME's advantages are that you can interpret an explanation the same way you reason about a linear model, and that it can be used on almost any model. Unfortunately, post-hoc local explanation methods, such as LIME, rely on neighborhood distributions to generate evaluation points. For particular inputs, such as time-series or image data, standard neighborhood generation methods may produce out of distribution examples or a limited type of perturbation. Such out of distribution examples or limited types of perturbations have a negative impact on the learned explanations, such as by omitting the relevant features that affect the decision of the post-hoc local explanation method. That is, such out of distribution examples or limited types of perturbations may result in misleading or non-local explanations thereby affecting the decision of the post-hoc local explanation method. Unfortunately, there is not currently a means for generating in-distribution samples of time-series or image data for the neighborhood distribution to be used by post-hoc local explanation methods thereby improving the accuracy of the decision making ability of the post-hoc local explanation method.

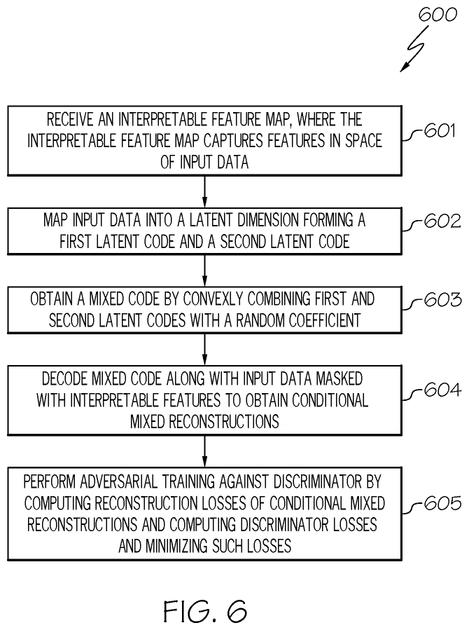

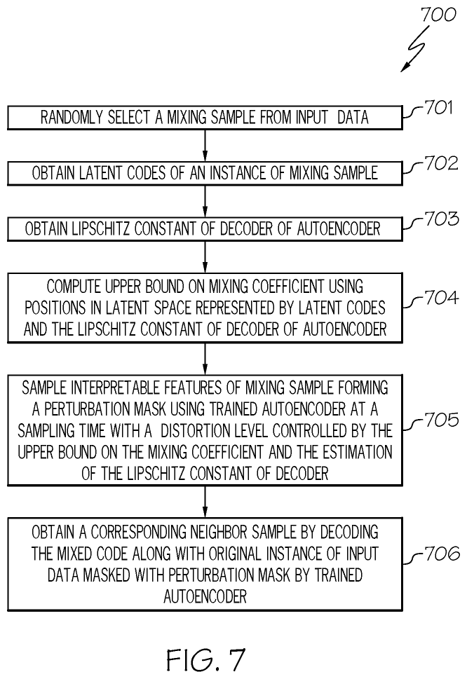

The embodiments of the present disclosure provide a means for generating in-distribution samples of time-series or image data for the neighborhood distribution to be used by post-hoc local explanation methods utilizing ideas from adversarial mix-up resynthesis as discussed below in connection with FIGS. 6 and 7. FIG. 6 is a flowchart of a method for training an autoencoder to generate in-distribution samples of input data for the neighborhood distribution to be used by a post-hoc local explanation method. FIG. 7 is a flowchart of a method for performing neighborhood sampling for a given instance.

As stated above, FIG. 6 is a flowchart of a method 600 for training an autoencoder to generate in-distribution samples of input data for the neighborhood distribution to be used by a post-hoc local explanation method in accordance with an embodiment of the present disclosure.

Referring to FIG. 6, in conjunction with FIGS. 1-5, in step 601, autoencoder trainer 201 of in-distribution sample generator 101 receives an interpretable feature map, where the interpretable feature map captures features in the space of input data 105, such as time series or image data.

As discussed above, in one embodiment, such a feature map captures the features (e.g., points, lines, edges, objects, areas) in the space of input patterns. Features are deemed to be interpretable if the features have a semantic content as opposed to uninterpretable features, which are features that are devoid of semantic content.

In one embodiment, the interpretable feature map is generated by applying filters or feature detectors to input data 105 or the feature map output of the prior layers of a convolutional neural network. For example, in one embodiment, the interpretable feature map is the output of one filter applied to a previous layer. A given filter is drawn across the entire previous layer, moved one pixel at a time. Each position results in an activation of the neuron and the output is collected in the feature map.

In one embodiment, such an interpretable feature map is generated via the use of labels, where the map includes the labeled features. In one embodiment, a label size is used to reduce the number of small features that are being labeled. For example, for those features that are insignificant that do not require a label, a minimum feature size can be specified whereby features that are smaller than such a minimum feature size will not be labeled. In one embodiment, such a minimum feature size is determined by an expert. In one embodiment, various software tools may be utilized by autoencoder trainer 201 to label features to be used to generate an interpretable feature map, including, but not limited to, doccano, Label studio, Universal data tool, awesome data labelling, labelbox®, V7, ImgLab, supervisely, SuperAnnotate, Dataloop®, VoTT, etc.

In step 602, encoder 301 of autoencoder 300 maps input data 105 (e.g., time series or image data) into a latent dimension or latent space forming a first latent code 304A and a second latent code 304B. In one embodiment, such input data 105 involves pairs of samples which are mapped into a latent dimension using encoder 301 forming first latent code 304A and a second latent code 304B.

As stated above, a “latent space,” as used herein, refers to a representation of compressed data in which similar data points are closer together in space. Latent space is useful for learning data features and for finding simpler representations of data for analysis. That is, latent space refers to an abstract multi-dimensional space containing feature values that cannot be interpreted directly, but which encodes a meaningful internal representation of externally observed events. Such feature values are referred to as “latent codes.”

Examples of the latent space include, but not limited to, image feature space, a variational autoencoder, a generative adversarial network, etc.

For example, encoder 301 may receive inputs χ and χ₁ which produce e_{χ} and e_{χ}_{₁}, representing the first and second latent codes 304A, 304B.

In step 603, mixing block 302 of autoencoder 300 obtains mixed code 305 by convexly combining the first and second latent codes 304A, 304B with a random coefficient. For example, mixing block 302 may convexly combine latent codes 304A, 304B with the random coefficient, αe_{χ}+·(1−α)e_{χ}_{₁}, to produce the convex combination e_{χ,χ}_{₁}₎^{mix}. Such a convex combination may be represented as follows:

e_{χ,χ}_{₁}₎^{mix}=αe_{X}+(1α)e_{X}_{₁}, α˜U[0,1]

In step 604, decoder 303 of autoencoder 300 decodes mixed code 305 with the input data masked with interpretable features (see element 306) obtained from the interpretable feature map (see step 301) to obtain conditional mixed reconstructions 307. The input data masked with interpretable features indicates which portions of the input data contain interpretable features. For example, input data masked with interpretable features may be represented as X∘Z, where Z represents the mask of interpretable features and X represents the input data. The output of decoder 303 corresponds to the conditional mixed reconstructions 307, represented by \hat{χ}, which corresponds to the neighborhood samples. The conditional mixed reconstruction 307 may be represented as follows:

\hat{X}=d_{Ψ}(e_{X,X}_{₁}₎^{mix}, X∘Z)

As discussed above, in one embodiment, in order to promote Z-localized perturbations (perturbations correspond. to small changes in the system, such as small changes in the gradients, weights, inputs, etc.), decoder 303 is conditioned on mask Z and includes a reconstruction loss. “Z-localized perturbations,” as used herein, refer to portions of an instance of input data 105 to be perturbed.

In one embodiment, autoencoder trainer 201 utilizations various software tools for building autoencoder 300, including the components of autoencoder 300 discussed above, including, but not limited to, Keras, DeepPy, neon, etc.

In step 605, autoencoder trainer 201 of in-distribution sample generator 101 performs adversarial training against discriminator 308 by computing reconstruction losses of conditional mixed reconstructions 307 and computing discriminator losses and minimizing such losses.

As stated above, in one embodiment, autoencoder trainer 201 runs a discriminator 308 against the output of autoencoder 300 (e.g., conditional mixed reconstructions 307). In one embodiment, the result is used to influence the cost function used to update the autoencoder's weights.

In one embodiment, in order to promote in-distribution samples, autoencoder trainer 301 performs adversarial training (augments training data with adversarial examples in each training loop) against discriminator 308 by computing reconstruction losses of conditional mixed reconstructions 307 and computing discriminator losses and minimizing the reconstruction and discriminator losses. In one embodiment, the mixed reconstruction losses are evaluated on the masked dimensions. A representation of the mixed reconstruction losses is shown in FIG. 4.

Furthermore, as discussed above, in one embodiment, autoencoder trainer 201 computes the discriminator losses, which are minimized, as shown below:

min_{D} [symbol] _{X}[BCE(d₁₀₅ (e_{X}, 0)), 1)]+ [symbol] _{X,X}_{₁}_{,Z}[BCE(D(\hat{X}), 1)]+ [symbol] _{X}[BCE(D(X), 0)]

Furthermore, in one embodiment, parameters for autoencoder 300 and discriminator 308 are updated by autoencoder trainer 201 using gradient descent in order to minimize both the mixed reconstruction and discriminator losses. Gradient descent, as used herein, refers to a first-order iterative optimization algorithm for finding a local minimum of a differentiable function. In one embodiment, the gradient descent algorithm takes repeated steps in the opposite direction of the gradient of the function at the current point because this is the direction of the steepest descent.

In one embodiment, the steps of 602-605 are repeated until the performance of discriminator 308 is acceptable, such as determined by an expert.

Upon training autoencoder 300 to generate in-distribution samples of input data for the neighborhood distribution to be used by a post-hoc local explanation method, a sampling procedure may be utilized to generate neighborhood samples for a given input x using the trained autoencoder 300 while controlling the maximum distortion level as discussed below in connection with FIG. 7.

As stated above, given a dataset of independent input samples [symbol] ={χᵢ}ᵢ₌₁ⁿ˜P_{X}^{⊗n}, the local neighborhood sampling procedure of the present disclosure can, for any given input χ and binary interpretable features z˜Ber (1−p)^{⊗}^{^{M}}, generate neighborhood samples \hat{χ} that satisfy z-localized perturbations (perturbations correspond to small changes in the system, such as small changes in the gradients, weights, inputs, etc.), in-distribution and distortion control. The Z-localized perturbations may he represented as \hat{χ}∘\hat{Z}=χ∘\hat{Z}, where \hat{Z}=mask (Z), which is the mask in the input dimensions associated with the interpretable features. Furthermore, in one embodiment, in-distribution is represented as P(\hat{x}∈ [symbol] )≥P(\hat{x}∉ [symbol] ) and distortion control is represented as: ∥χ−\hat{χ}∥₂²≤δ, δ˜P_{Δ}, where P_{Δ} is a distribution over positive real numbers.

A discussion regarding such a sampling procedure that satisfies such constraints is provided below in connection with FIG. 7.

FIG. 7 is a flowchart of a method 700 for performing neighborhood sampling for a given instance in accordance with an embodiment of the present disclosure. Such a given instance is provided in order to explain and provide its latent code.

Referring to FIG. 7, in conjunction with FIGS. 1-6, in step 701, sampling mechanism 202 of in-distribution sample generator 101 randomly selects a mixing sample from input data 105. A “mixing sample,” as used herein, refers to randomly selecting different portions of input data 105 to form a single sample of data.

For example, in one embodiment, for a given instance X, a mixing sample from dataset 105 and a maximum distortion δ are obtained:

δ:X₁˜ [symbol] , δ˜P₆₆

In one embodiment, sampling mechanism 202 randomly selects a mixing sample from input data 105 using various software tools including, but not limited to, IBM® SPSS®, Stata®, JMP®, EViews, RStudio®, etc.

In step 702, sampling mechanism 202 of in-distribution sample generator 101 obtains the latent codes, latent codes 304A, 304B, of an instance of the mixing sample, such as via encoder 301.

In step 703, sampling mechanism 202 of in-distribution sample generator 101 obtains an empirical estimate of the Lipschitz constant (L) of decoder 303 of autoencoder 300. In one embodiment, the empirical estimate of the Lipschitz constant (L) of decoder 303 is provided by an expert. In one embodiment, the Lipschitz constant (L) of decoder 303 is estimated after training is completed.

In step 704, sampling mechanism 202 of in-distribution sample generator 101 computes the upper bound (maximum value, α_{M}) on a mixing coefficient (coefficient of mixing block 302, such as αe_{χ}+·(1−α)e_{χ}_{₁}, using the positions in latent space represented by latent codes 304A, 304B and the Lipschitz constant (L) of decoder 303 of autoencoder 300. The formula to compute the upper bound is the following:

$${α}_{M} = min ( \sqrt{\frac{δ}{L {‖ {e}_{x} - {e}_{{x}^{′}} ‖}_{2}^{2}}} , 1 ) , α ∈ U [ 0 , {α}_{M} ]$$

As stated above, in one embodiment, such an upper bound on the mixing coefficient is computed using the distance between the latent location of a pre-selected feature value, which may be pre-selected by an expert, and the latent locations of the feature values represented by latent codes 304A, 304B thereby forming a first distance (distance between the latent location of the pre-selected feature value and the latent location of the feature value represented by latent code 304A) and a second distance (distance between the latent location of the pre-selected feature value and the latent location of the feature value represented by latent code 304B). For example, the upper bound or maximum value of the mixing coefficient (e.g., αe_{χ}+·(1−α)e_{χ}_{₁}) is computed using such distances (first and second distances), represented as e_{χ} and e_{χ}_{₁}, respectively.

In one embodiment, the distortion level at sampling time is controlled by upper bounding the mixing coefficient using an estimation of the decoder's Lipschitz constant (L).

In step 705, sampling mechanism 202 of in-distribution sample generator 101 samples the interpretable features of the mixing sample forming a perturbation mask (indicating which portions of the instance of the mixing sample to be perturbed) using the trained autoencoder 300 at a sampling time with a distortion level controlled by the upper bound on the mixing coefficient and the estimation of the Lipschitz constant of decoder 303. By sampling the interpretable features of the mixing sample to form a perturbation mask, such a mask indicates which input dimensions (e.g., lines, edges, objects, etc.) will be perturbed.

As discussed above, in one embodiment, sampling mechanism 202 uses various software tools for such sampling, including, but not limited to, IBM® SPSS®, SAS®, Minitab®, etc.

In step 706, sampling mechanism 202 of in-distribution sample generator 101 obtains a corresponding neighbor sample by decoding the mixed code 305 along with the original instance of input data 105 that is masked with the perturbation mask by the trained autoencoder 300. This is shown by the following equations:

χ=d_{Ψ}(e_{χ,χ′}^{mix}, χ∘z)

e_{χ,χ′}^{mix}=αe_{χ′}+(1−α)e_{χ}

z˜Ber(1−p)^{⊗M}

In this manner, the principles of the present disclosure generate in-distribution samples of time-series or image data for the neighborhood distribution that are used by post-hoc local explanation methods thereby improving the decision making ability of the post-hoc local explanation method.

Furthermore, embodiments of the present disclosure generate samples close to a given point that enable masked perturbations while maintaining in-distribution properties.

Furthermore, the principles of the present disclosure improve the technology or technical field involving artificial intelligence methods.

As discussed above, blackbox artificial intelligence (AI) methods (e.g., deep neural networks) have been widely utilized to build predictive models that can extract complex relationships in a dataset and make predictions for new unseen data records. However, it is difficult to trust decisions made by such methods since their inner working and decision logic is hidden from the user. Post-hoc local explanation methods approximate the behavior of a black-box by extracting the relationships between feature values and the predictions. An example of a post-hoc local explanation method is the local interpretable model-agnostic explanation (LIME) method. LIME is a method that fits a surrogate glassbox model around the decision space of any blackbox model's prediction. LIME explicitly tries to model the local neighborhood (feasible solution space used to find the optimum or near optimum solution for the problem) of any prediction—by focusing on a narrow enough decision surface. Users can then inspect the glassbox model to understand how the blackbox model behaves in that region. LIME works by perturbing any individual datapoint (perturbations correspond. to small changes in the system, such as small changes in the weights, inputs, etc.) and generating synthetic data which gets evaluated by the blackbox system, and ultimately used as a training set for the glassbox model LIME' s advantages are that you can interpret an explanation the same way you reason about a linear model, and that it can be used on almost any model. Unfortunately, post-hoc local explanation methods, such as LIME, rely on neighborhood distributions to generate evaluation points. For particular inputs, such as time-series or image data, standard neighborhood generation methods may produce out of distribution examples or a limited type of perturbation. Such out of distribution examples or limited types of perturbations have a negative impact on the learned explanations, such as by omitting the relevant features that affect the decision of the post-hoc local explanation method. That is, such out of distribution examples or limited types of perturbations may result in misleading or non-local explanations thereby affecting the decision of the post-hoc local explanation method. Unfortunately, there is not currently a means for generating in-distribution samples of time-series or image data for the neighborhood distribution to be used by post-hoc local explanation methods thereby improving the accuracy of the decision making ability of the post-hoc local explanation method.

Embodiments of the present disclosure improve such technology by training an autoencoder to generate in-distribution samples of input data for the neighborhood distribution to be used by a post-hoc local explanation method. An “autoencoder,” as used herein, is an unsupervised artificial neural network that learns how to efficiently compress and encode data and then learns how to reconstruct the data from the reduced encoded representation to a representation that is as close to the original input as possible. In one embodiment, an autoencoder is trained to reconstruct its inputs after being processed by two neural networks: an encoder which encodes the input to a high-level representation and a decoder which performs the reconstruction using that representation as input. Such training includes mapping the input data, such as time series or image data, into a latent dimension (or latent space) forming a first latent code and a second latent code. “Latent space,” as used herein, refers to a representation of compressed data in which similar data points are closer together in space. That is, latent space refers to an abstract multi-dimensional space containing feature values that cannot be interpreted directly, but which encodes a meaningful internal representation of externally observed events. Such feature values are referred to as “latent codes.” A mixed code is then obtained by convexly combining the first and second latent codes with a random coefficient. The mixed code is then decoded with the input data masked with interpretable features (features having a semantic content) to obtain conditional mixed reconstructions. The input data masked with interpretable features indicates which portions of the input data contain interpretable features. Adversarial training is then performed against a discriminator in order to promote in-distribution samples by computing the reconstruction losses of the conditional mixed reconstructions as well as the discriminator losses and then minimizing such losses. Upon training the autoencoder to generate in-distribution samples of input data for the neighborhood distribution to be used by a post-hoc local explanation method, a sampling procedure may be utilized to generate neighborhood samples for a given input using the trained autoencoder while controlling the maximum distortion level. In this manner, the principles of the present disclosure generate in-distribution samples of time-series or image data for the neighborhood distribution that are used by post-hoc local explanation methods thereby improving the decision making ability of the post-hoc local explanation method. Furthermore, in this manner, there is an improvement in the technical field involving artificial intelligence methods.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for generating in-distribution samples of data for a neighborhood distribution to be used by post-hoc local explanation methods, the method comprising:
training an autoencoder to generate in-distribution samples of input data for said neighborhood distribution to be used by a post-hoc local explanation method, wherein said training comprises:
mapping said input data into a latent dimension forming a first latent code and a second latent code by an encoder;
obtaining a mixed code by convexly combining said first and second latent codes with a random coefficient by a mixing block;
decoding said mixed code along with said input data masked with interpretable features to obtain conditional mixed reconstructions by a decoder; and
performing adversarial training against a discriminator by computing reconstruction losses of said conditional mixed reconstructions and computing discriminator losses and minimizing said reconstruction losses and said discriminator losses.

2. The method as recited in claim 1 further comprising:
randomly selecting a mixing sample from said input data; and
obtaining latent codes of an instance of said mixing sample.

3. The method as recited in claim 2 further comprising:
obtaining an estimation of a Lipschitz constant of said decoder.

4. The method as recited in claim 3 further comprising:
computing an upper bound on a mixing coefficient using positions in said latent dimension represented by said obtained latent codes and said Lipschitz constant of said decoder.

5. The method as recited in claim 4 further comprising:
sampling interpretable features of said mixing sample forming a perturbation mask using said trained autoencoder at a sampling time with a distortion level controlled by said upper bound on said mixing coefficient and said estimation of said Lipschitz constant of said decoder.

6. The method as recited in claim 5 further comprising:
obtaining a corresponding neighbor sample by decoding said mixed code by said trained autoencoder along with an original instance of said input data masked by said perturbation mask.

7. The method as recited in claim 1, wherein said input data comprises time-series or image data.

8. A computer program product for generating in-distribution samples of data for a neighborhood distribution to be used by post-hoc local explanation methods, the computer program product comprising one or more computer readable storage mediums having program code embodied therewith, the program code comprising programming instructions for:
training an autoencoder to generate in-distribution samples of input data for said neighborhood distribution to be used by a post-hoc local explanation method, wherein said training comprises:
mapping said input data into a latent dimension forming a first latent code and a second latent code by an encoder;
obtaining a mixed code by convexly combining said first and second latent codes with a random coefficient by a mixing block;
decoding said mixed code along with said input data masked with interpretable features to obtain conditional mixed reconstructions by a decoder; and
performing adversarial training against a discriminator by computing reconstruction losses of said conditional mixed reconstructions and computing discriminator losses and minimizing said reconstruction losses and said discriminator losses.

9. The computer program product as recited in claim 8, wherein the program code further comprises the programming instructions for:
randomly selecting a mixing sample from said input data; and
obtaining latent codes of an instance of said mixing sample.

10. The computer program product as recited in claim 9, wherein the program code further comprises the programming instructions for:
obtaining an estimation of a Lipschitz constant of said decoder.

11. The computer program product as recited in claim 10, wherein the program code further comprises the programming instructions for:
computing an upper bound on a mixing coefficient using positions in said latent dimension represented by said obtained latent codes and said Lipschitz constant of said decoder.

12. The computer program product as recited in claim 11, wherein the program code further comprises the programming instructions for:
sampling interpretable features of said mixing sample forming a perturbation mask using said trained autoencoder at a sampling time with a distortion level controlled by said upper bound on said mixing coefficient and said estimation of said Lipschitz constant of said decoder.

13. The computer program product as recited in claim 12, wherein the program code further comprises the programming instructions for:
obtaining a corresponding neighbor sample by decoding said mixed code by said trained autoencoder along with an original instance of said input data masked by said perturbation mask.

14. The computer program product as recited in claim 8, wherein said input data comprises time-series or image data.

15. A system, comprising:
a memory for storing a computer program for generating in-distribution samples of data for a neighborhood distribution to be used by post-hoc local explanation methods; and
a processor connected to said memory, wherein said processor is configured to execute program instructions of the computer program comprising:
training an autoencoder to generate in-distribution samples of input data for said neighborhood distribution to be used by a post-hoc local explanation method, wherein said training comprises:
mapping said input data into a latent dimension forming a first latent code and a second latent code by an encoder;
obtaining a mixed code by convexly combining said first and second latent codes with a random coefficient by a mixing block;
decoding said mixed code along with said input data masked with interpretable features to obtain conditional mixed reconstructions by a decoder; and
performing adversarial training against a discriminator by computing reconstruction losses of said conditional mixed reconstructions and computing discriminator losses and minimizing said reconstruction losses and said discriminator losses.

16. The system as recited in claim 15, wherein the program instructions of the computer program further comprise:
randomly selecting a mixing sample from said input data; and
obtaining latent codes of an instance of said mixing sample.

17. The system as recited in claim 16, wherein the program instructions of the computer program further comprise:
obtaining an estimation of a Lipschitz constant of said decoder.

18. The system as recited in claim 17, wherein the program instructions of the computer program further comprise:
computing an upper bound on a mixing coefficient using positions in said latent dimension represented by said obtained latent codes and said Lipschitz constant of said decoder.

19. The system as recited in claim 18, wherein the program instructions of the computer program further comprise:
sampling interpretable features of said mixing sample forming a perturbation mask using said trained autoencoder at a sampling time with a distortion level controlled by said upper bound on said mixing coefficient and said estimation of said Lipschitz constant of said decoder.

20. The system as recited in claim 19, wherein the program instructions of the computer program further comprise:
obtaining a corresponding neighbor sample by decoding said mixed code by said trained autoencoder along with an original instance of said input data masked by said perturbation mask.
